(19) United States
(12) Patent Application Publication
(10) Pub. No.: US 2017/0001256 A1
(43) Pub. Date: Jan. 5, 2017

(54) VIBRATION SPOT WELDING DEVICE

(71) Applicant: SUNGWOO HITECH CO., LTD., Busan (KR)

(72) Inventors: Jeong Jae HWANG, Busan (KR); Mun Yong LEE, Busan (KR)

(21) Appl. No.: 14/924,812

(22) Filed: Oct. 28, 2015

(30) Foreign Application Priority Data
Jul. 3, 2015 (KR) 10-2015-0095550

(51) Int. Cl. B23K 11/12; B23K 11/30; B23K 11/11

(52) U.S. Cl. CPC B23K 11/12; B23K 11/115; B23K 11/3009

(57) ABSTRACT

A vibration spot welding device according to an exemplary embodiment of the present invention may include a first welding tip that is disposed to contact one side surface of metal plates that are overlapped, and a second welding tip that is disposed to contact the other side surface of the metal plates corresponding to the first welding tip, wherein the second welding tip includes a first electrode portion that is disposed to contact the metal plate so as to transmit a current thereto, and a second electrode portion that is disposed to contact the metal plate so as to receive the current that is transferred from the first electrode portion through the metal plate.

### CROSS-REFERENCE TO RELATED APPLICATION

This application claims priority to and the benefit of Korean Patent Application No. 10-2015-0095550 filed in the Korean Intellectual Property Office on Jul. 3, 2015, the entire contents of which are incorporated herein by reference.

### BACKGROUND OF THE INVENTION

(a) Field of the Invention

The present invention relates to vibration spot welding that applies a predetermined portion of overlapped metals with a current and applies vibration to the portion so as to weld and engage the overlapped metals.

(b) Description of the Related Art

Generally, there are a fusion welding method and a solid phase welding method as methods for welding two overlapped metals.

The fusion welding method includes spot welding, and the spot welding method melts a welding portion by using electrical resistance heat and pressure so as to join the overlapped metals.

The solid phase welding method includes a friction stir welding method, and the friction stir welding method generates heat through friction, the material around tools is melted, and the materials of both parts are forcibly mixed by plastic flow such that the parts are welded.

The spot welding and friction stir welding each have merits and drawbacks, for example, the spot welding has a drawback that an arc is generated at contact surfaces of the metal plates and the welding surface is not smooth, because the welding portion of the metal plates are melted by the heat that is generated from the electrical resistance.

The friction stir welding is a solid phase welding method, a mechanical strength of the welding plates is excellent, and because the arc is not generated, there is a merit for welding light metals, but there is a drawback that a welding mark or a welding hole is formed on the welding surface.

As a welding method that combines the merits of the spot welding and the friction stir welding, a vibration spot welding device has been developed, and this device uses current to generate heat and applies vibration so as to effectively join the welded portions.

Meanwhile, two overlapped metal plates are prepared to be welded, they have to be made of electrically conductive materials so as to transmit current to an upper plate and a lower plate, and it is necessary to transmit a current from an upper tip to a lower tip. As a conventional art, there is Korea Patent No. 743857.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a vibration spot welding device having advantages of applying current to a welding portion of overlapped metal plates to generate heat therein and simultaneously giving a repeated vibration load to weld the overlapped metal plates.

As described above, a vibration spot welding device according to an exemplary embodiment of the present invention may include a first welding tip that is disposed to contact one side surface of metal plates that are overlapped, and a second welding tip that is disposed to contact the other side surface of the metal plates corresponding to the first welding tip, wherein the second welding tip includes a first electrode portion that is disposed to contact the metal plate so as to transmit a current thereto, and a second electrode portion that is disposed to contact the metal plate so as to receive the current that is transferred from the first electrode portion through the metal plate.

The first welding tip may include a vibration element that applies a vibration.

The vibration element may be shaken in a thickness direction of the metal plate such that the melted portion of the metal plate can be mixed.

The first welding tip may include a pipe bush that is disposed to cover an external circumference surface of the vibration element and an end portion surface thereof corresponds to one surface of the metal plate, and a tip housing that is disposed to cover an external circumference surface of the pipe bush and closely contact one surface of the metal plate such that the metal plates contact each other.

The second welding tip may include an insulation member that is interposed between the first electrode portion and the second electrode portion.

The insulation member may be disposed at a position corresponding to the vibration element, and the first electrode portion and the second electrode portion are disposed at both side surfaces of the insulation member.

The vibration spot welding device may further include a fixation portion that fixes the first electrode portion or the second electrode portion on the insulation member

An external circumferential surface of the vibration element and the pipe bush may be engaged to be able to slide with each other.

The vibration spot welding device may further include an adapter in which the second welding tip is inserted into and receives current from the outside, and one side of the interior circumference of the adapter contacts the first electrode portion.

A surface that the first welding tip and the second welding tip respectively may contact the metal plate has a circular shape.

A vibration spot welding device may include a first welding tip that is disposed to contact one outer surface of the metal plates overlapped with each other and a vibration element is disposed therein to transmit a vibration on the metal plate, and a second welding tip that is disposed to contact the other outer surface of the metal plates and includes a first electrode portion for transmitting current to the metal plate and a second electrode portion for receiving the current, an insulation member that is interposed between the first electrode portion and the second electrode portion in the second welding tip, and a fixation portion that fixes the first electrode portion or the second electrode portion to the insulation member.

One surface of the second welding tip that contacts one surface of the metal plate may have a circular shape, and the insulation member is formed to pass a center portion of the circular shape.

The first electrode portion and the second electrode portion may have fan shapes that are symmetrically formed based on a center of the circular shape.

In accordance with an exemplary embodiment of the present invention for realizing the objects, applying the metal plate with a vibration is performed by a first welding tip and applying the metal plate with a current is performed by a second welding tip, and this configuration effectively controls a solid joining condition.

Further, a current is applied by the second welding tip of two welding tips to the metal plate, and one of two metal plates can be a non-conductive metal and the other thereof can be a conductive metal.

### BRIEF DESCRIPTION OF THE DRAWINGS

FIG. 1 is an overall perspective view of a vibration spot welding device related to the present invention.

FIG. 2 is a perspective view of a first welding tip of a vibration welding device related to the present invention.

FIG. 3 is a perspective view of a second welding tip of a vibration spot welding device related to the present invention.

FIG. 4 is a schematic diagram showing a welding principle of a vibration spot welding device according to an exemplary embodiment of the present invention.

FIG. 5 is a perspective view of a first welding tip and a second welding tip of a vibration spot welding device according to an exemplary embodiment of the present invention.

FIG. 6 is a perspective view of a second welding tip of a vibration spot welding device according to an exemplary embodiment of the present invention.

FIG. 7 is a schematic diagram of a vibration spot welding device according to an exemplary embodiment of the present invention.

### DETAILED DESCRIPTION OF THE EMBODIMENTS

An exemplary embodiment of the present invention will hereinafter be described in detail with reference to the accompanying drawings.

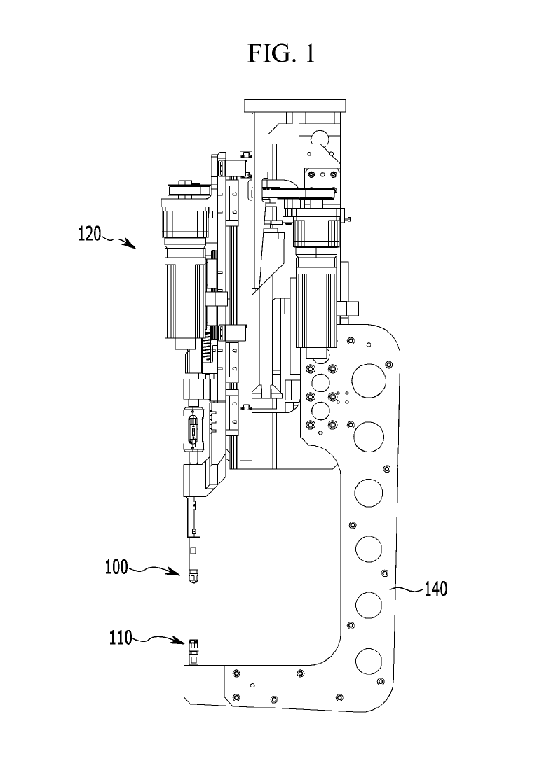

FIG. 1 is an overall perspective view of a vibration spot welding device related to the present invention.

Referring to FIG. 1, a vibration spot welding device include a driving portion 120, a first welding tip 100, a second welding tip 110, and a frame 140.

The driving portion 120 is disposed at an upper side of the frame 140, the first welding tip 100 is disposed at a lower portion of the driving portion 120 with its tip downward, and the second welding tip 110 is disposed at a lower portion of the frame 140 coaxially with the first welding tip 100 with its tip upward.

The driving portion 120 moves the first welding tip 100 down and generates vibration on the first welding tip 100. Further, the driving portion 120 transmits current to the first welding tip 100 or the second welding tip 110.

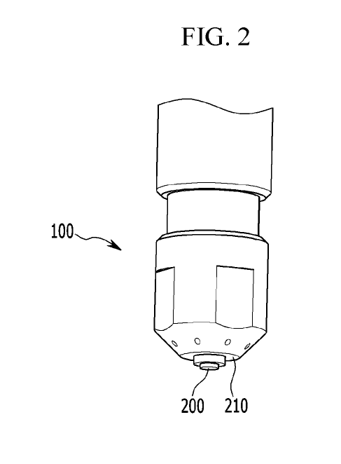

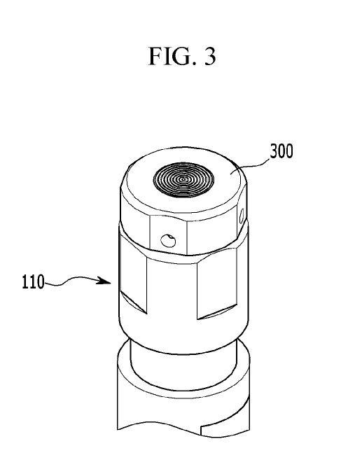

FIG. 2 is a perspective view of a first welding tip of a vibration welding device related to the present invention, and FIG. 3 is a perspective view of a second welding tip of a vibration spot welding device related to the present invention.

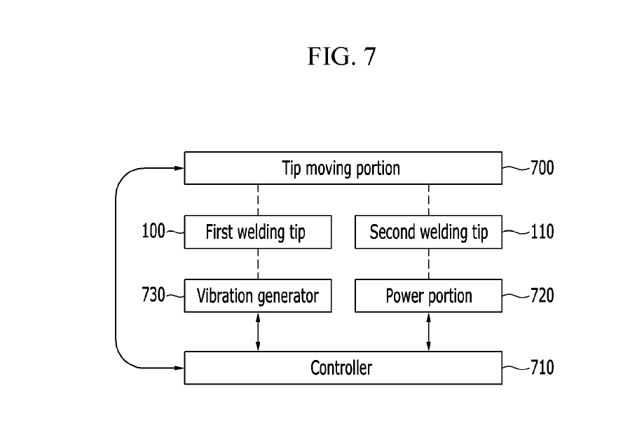

Referring to FIG. 2, a vibration element 200 and a first electrode portion 210 are formed at a lower end portion of the first welding tip 100. A vibration generator (730 of FIG. 7) is disposed at an upper side of the vibration element 200, and the vibration that is generated by the vibration generator 730 is transferred to the vibration element 200. Further, the first electrode portion 210 is formed around the vibration element 200 to transmit current to the metal plate.

Referring to FIG. 3, a second electrode portion 300 is fixed on an upper end portion of the second welding tip 110 to receive a current that is supplied from the first electrode portion 210 through the metal plate.

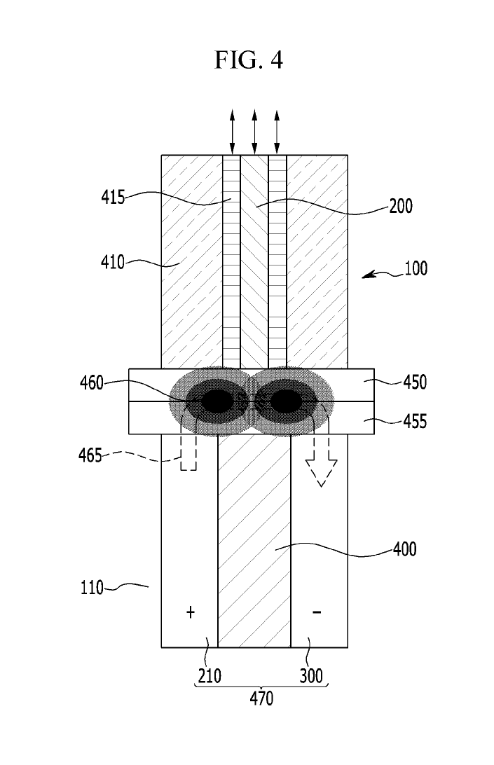

FIG. 4 is a schematic diagram showing a welding principle of a vibration spot welding device according to an exemplary embodiment of the present invention.

Referring to FIG. 4, a first welding tip 100 includes a vibration element 200, a pipe bush 415, and a tip housing 410. The tip housing 410 is a pipe type, the pipe bush 415 is inserted therein, and an external circumference surface of the pipe bush 415 contacts an interior circumference surface of the tip housing 410.

Further, the pipe bush 415 is a pipe type, a shaft type of the vibration element 200 is inserted therein, and an external circumferential surface of the vibration element 200 contacts an interior circumferential surface of the pipe bush 415.

The second welding tip 110 includes an insulation member 400 that is disposed at a central portion and an electrode portion 470 that is disposed at both sides based on the insulation member 400, and the electrode portion 470 includes a first electrode portion 210 that transmits a current and a second electrode portion 300 that receives the current.

As shown in the drawing, an upper plate 450 and a lower plate 455 are overlapped between the first welding tip 100 and the second welding tip 110, the tip housing 410 of the first welding tip 100 contacts an upper surface of the upper plate 450, and the vibration element 200 applies vibration on an outside surface of the upper plate 450.

Further, the first electrode portion 210 transmits a current to one side of the lower plate 455 based on the insulation member 400, and the second electrode portion 300 receives the current that is transferred through the lower plate 455.

Current flows along a current route 465 that is formed in the upper plate 450 and the lower plate 455 between the first electrode portion 210 and the second electrode portion 300, and a welding nugget 460 is formed on the current route between the upper plate 450 and the lower plate 455 at a position that corresponds to the vibration element 200 and the insulation member 400.

As described above, because the second welding tip 110 transmits and receives the current, the lower plate 455 can be a conductor and the upper plate 450 can be an insulator. Further, a vibration element 200 is disposed on the first welding tip 100, and the element 200 applies vibration between the upper plate 450 and the lower plate 455 to effectively perform electrical resistance welding.

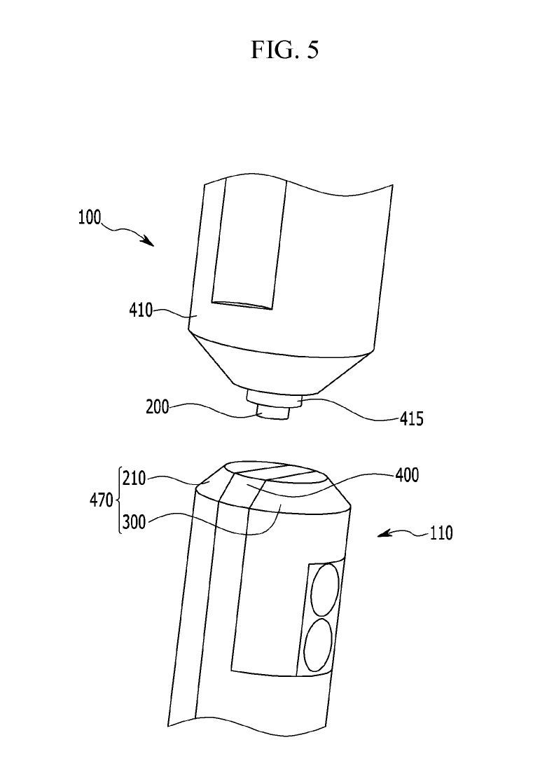

FIG. 5 is a perspective view of a first welding tip and a second welding tip of a vibration spot welding device according to an exemplary embodiment of the present invention.

Referring to FIG. 5, the tip housing 410 is disposed at an outside of a lower end surface of the first welding tip 100, the pipe bush 415 is inserted into a central portion of the tip housing 410, the vibration element 200 is inserted into the pipe bush 415, the pipe bush 415 protrudes from a lower end surface of the tip housing 410 by a predetermined distance, and the vibration element 200 is disposed to protrude from a lower end surface of the pipe bush 415.

The vibration element 200 and the pipe bush are disposed to be able to move up and down in the tip housing, and a lower end surface of the vibration element 200 and the pipe bush 415 can be disposed to be parallel to a lower end surface of the tip housing 410.

The second welding tip 110 includes an insulation member 400, a first electrode portion 210, and a second electrode portion 300, the first electrode portion 210 is disposed at one side based on the insulation member 400, and the second electrode portion 300 is disposed at the other side of the insulation member 400. Further, the vibration element 200 is disposed at a center portion of a circle corresponding to the insulation member 400.

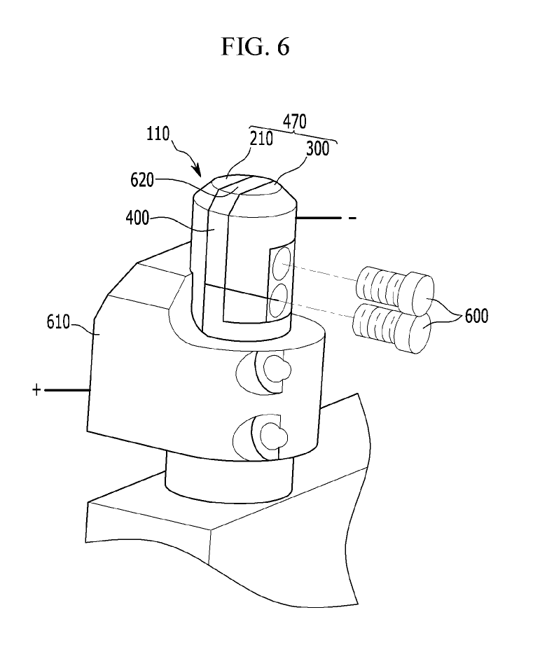

FIG. 6 is a perspective view of a second welding tip of a vibration spot welding device according to an exemplary embodiment of the present invention.

Referring to FIG. 6, a hole in which an engagement bolt 600 is inserted to be engaged therewith is formed at the second electrode portion 300, and the engagement bolt 600 is engaged with the hole of the second electrode portion 300 to fix the second electrode portion 300 with the insulation member 400.

The second welding tip 110 penetrates an adapter 610 and is disposed to protrude at an upper side, and the adapter 610 is fixed at a lower portion of the second electrode portion 300.

An interior circumferential surface of the adapter 610 contacts an external circumferential surface of the first electrode portion 210, and the adapter 610 is electrically connected to the first electrode portion 210 to transmit outside power to the first electrode portion 210.

A surface at which the insulation member 400 and the first and second electrode portions 470 contact the lower plate 455 has a circular shape, a center point 620 is formed at a central portion of the insulation member 400, and upper end surfaces of the first and second electrode portions 470 have a fan shape and are symmetrically formed based on the center point 620.

FIG. 7 is a schematic diagram of a vibration spot welding device according to an exemplary embodiment of the present invention.

Referring to FIG. 7, a vibration spot welding system includes a first welding tip 100, a second welding tip 110, a tip moving portion 700, a vibration generator 730, a power portion 720, and a controller 710.

The tip moving portion 700 moves the first welding tip 100 or the second welding tip 110 to make the tips contact the upper plate and the lower plate, and the vibration generator 730 generates vibration and transmits the vibration to the vibration element 200.

Further, the power portion 720 transmits a current to the first electrode portion 210 or the second electrode portion 300 of the second welding tip 110, and the controller 710 controls the tip moving portion 700, the vibration generator 730, and the power portion 720.

In an exemplary embodiment of the present invention, it has been described that the first welding tip 100 is disposed at an upper portion and the second welding tip 110 is disposed at a lower portion, the first welding tip 100 and the second welding tip 110 are disposed in a horizontal direction, and the first welding tip 100 and the second welding tip 110 are disposed along a slanted line.

Also, in an exemplary embodiment of the present invention, it has been described that two metal plates are overlapped and the first and second welding tips (100 and 110) weld them, but the first and second welding tips can weld two or more metal plates.

Also, in an exemplary embodiment of the present invention, the upper plate 450 contacting the first welding tip 100 is an aluminum material, and the lower plate 455 contacting the second welding tip 110 can be a steel material. Further, the upper plate 450 and the lower plate 455 can be selected from aluminum or steel, or a composite material thereof.

In addition, in an exemplary embodiment of the present invention, the first electrode portion 210, the second electrode portion 300, and the adapter 610 are made of a copper alloy to reduce current resistance, and the insulation member 400 can be a non-metal on which an insulation material is coated.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 100: first welding tip | 110: second welding tip |
| 120: driving portion | 140: frame |
| 200: vibration element | 470: electrode portion |
| 210: first electrode portion | 300: second electrode portion |
| 400: insulation member | 410: tip housing |
| 415: pipe bush | 450: upper plate |
| 455: lower plate | 460: welding nugget |
| 465: current route | 600: engagement bolt |
| 610: adapter | 700: tip moving portion |
| 710: controller | 720: power portion |
| 730: vibration generator | |

What is claimed is:

1. A vibration spot welding device, comprising
a first welding tip that is disposed to contact one side surface of metal plates that are overlapped, and
a second welding tip that is disposed to contact the other side surface of the metal plates corresponding to the first welding tip,
wherein the second welding tip includes:
a first electrode portion that is disposed to contact the metal plate so as to transmit a current thereto; and
a second electrode portion that is disposed to contact the metal plate so as to receive the current that is transferred from the first electrode portion through the metal plate.

2. The vibration spot welding device of claim 1, wherein the first welding tip includes a vibration element that applies a vibration.

3. The vibration spot welding device of claim 2, wherein the vibration element is shaken in a thickness direction of the metal plate such that the melted portion of the metal plate can be mixed.

4. The vibration spot welding device of claim 2, wherein the first welding tip includes:
a pipe bush that is disposed to cover an external circumference surface of the vibration element and an end portion surface thereof corresponds to one surface of the metal plate; and
a tip housing that is disposed to cover an external circumference surface of the pipe bush and closely contact one surface of the metal plate such that the metal plates contact each other.

5. The vibration spot welding device of claim 1, wherein the second welding tip includes an insulation member that is interposed between the first electrode portion and the second electrode portion.

6. The vibration spot welding device of claim 5, wherein the insulation member is disposed at a position corresponding to the vibration element, and the first electrode portion and the second electrode portion are disposed at both side surfaces of the insulation member.

7. The vibration spot welding device of claim 5, further comprising a fixation portion that fixes the first electrode portion or the second electrode portion on the insulation member.

8. The vibration spot welding device of claim 4, wherein an external circumferential surface of the vibration element and the pipe bush are engaged to be able to slide with each other.

9. The vibration spot welding device of claim 1, further comprising an adapter in which the second welding tip is inserted into and receives current from the outside, and one side of the interior circumference of the adapter contacts the first electrode portion.

10. The vibration spot welding device of claim 1, wherein a surface that the first welding tip and the second welding tip respectively contact the metal plate has a circular shape.

11. A vibration spot welding device, comprising:
a first welding tip that is disposed to contact one outer surface of the metal plates overlapped with each other and a vibration element is disposed therein to transmit a vibration on the metal plate; and
a second welding tip that is disposed to contact the other outer surface of the metal plates and includes a first electrode portion for transmitting current to the metal plate and a second electrode portion for receiving the current;
an insulation member that is interposed between the first electrode portion and the second electrode portion in the second welding tip; and
a fixation portion that fixes the first electrode portion or the second electrode portion to the insulation member.

12. The vibration spot welding device of claim 11, one surface of the second welding tip that contacts one surface of the metal plate has a circular shape, and the insulation member is formed to pass a center portion of the circular shape.

13. The vibration spot welding device of claim 12, wherein the first electrode portion and the second electrode portion have fan shapes that are symmetrically formed based on a center of the circular shape.
